(19) United States
(12) Patent Application Publication
(10) Pub. No.: US 2002/0018067 A1
(43) Pub. Date: Feb. 14, 2002

(54) System for reproducing images in an altered form in accordance with sound characteristics

(76) Inventors: Peter P. Carcia, Reading, MA (US); Israel Meir, Brookline, MA (US); Eric W. Higgins, Newton, MA (US)

Correspondence Address: Paul M. Coryea, POLAROID CORPORATION, Patent Department, 784 Memorial Drive, Cambridge, MA, 02139, US

(21) Appl. No.: 09/845,013

(22) Filed: Apr. 27, 2001

Related U.S. Application Data
(60) Provisional application No. 60/223,753, filed on Aug. 8, 2000.

(51) Int. Cl. G06T 13/00

(52) U.S. Cl. 345/473

(57) ABSTRACT

A system for altering still images in accordance with sound characteristics includes a digital camera for producing a plurality of digital images; a source of sound; an analyzer device for analyzing and selecting characteristics of the sound for altering a selected digital image; means for altering the selected digital image in accordance with the selected sound characteristics; a display for displaying the images in accordance with the sound; and a printer for printing an altered image.

### BACKGROUND OF THE INVENTION

The present invention generally relates to systems or devices for producing images with sound and, more specifically, to a novel system for altering and animating still images in accordance with characteristics of sound.

An object of the invention is to provide a novel system that will allow digital still images to be altered in a variety of ways including geometry and/or color in accordance with characteristics of sound. The sound may or may not be presented simultaneously with the images. Included herein is such a system that may be incorporated in a digital camera, scanner, computer, and printer or represented in software, hardware, firmware, or an integrated circuit.

A further object of the present invention is to provide a novel system for altering still digital images in accordance with characteristics of sound and for displaying the altered image or altered images in animated fashion, preferably, in conjunction with the sound. Included herein is such a system that will enable the user to display and/or select and print an altered image, or upload altered images to a computer or the internet with or without sound and/or display.

### SUMMARY OF PREFERRED EMBODIMENTS OF PRESENT INVENTION

A system in accordance with one preferred embodiment of the present invention includes a source of one digital image; a source of sound; an analyzer device for analyzing and selecting characteristics of the sound from the source for purposes of altering at least a selected digital image; means for altering the selected digital image in accordance with the selected sound characteristics.

Another system in accordance with a preferred embodiment of the present invention includes a digital camera for producing a plurality of digital images; a source of sound; an analyzer device for analyzing and selecting characteristics of the sound from the source for altering a selected digital image; means for altering the selected digital image in accordance with the selected sound characteristics.

The system in accordance with another preferred version which further embodies a display for displaying the images with or without the sound; and, printer for printing the altered images.

The system in accordance with another preferred embodiment is adapted to provide a sound/image stream and immediately save to storage for later display and sound reproduction. There would be no display or printer. An example would be a camera that uploads the data directly to the Internet for sharing of clips or a card/chip that could be sold to camera makers to add as functionality to their devices.

The system in accordance with another preferred version is embodied as software that alters selected digital images in accordance with sound characteristics that are selected from a source of sound, whereby the altered digital images with or without sound can be stored in a recording medium, uploaded to a computer and/or the internet.

### BRIEF DESCRIPTION OF THE DRAWINGS

Other objects and advantages of the present invention will become apparent from the following more detailed description taken in conjunction with the attached drawing in which:

FIG. 1 is a schematic block diagram of a system constituting a preferred embodiment of the system of the present invention.

FIG. 2 is a photograph of an image that is desired to be altered or morphed.

FIG. 3 is a photograph of an image that has been altered in accordance with a geometric transform.

FIG. 4 is a photograph of an image that has been altered in accordance with a color transform.

FIG. 5 is schematic block diagram of a system constituting another preferred embodiment of the system of the present invention.

### DETAILED DESCRIPTION

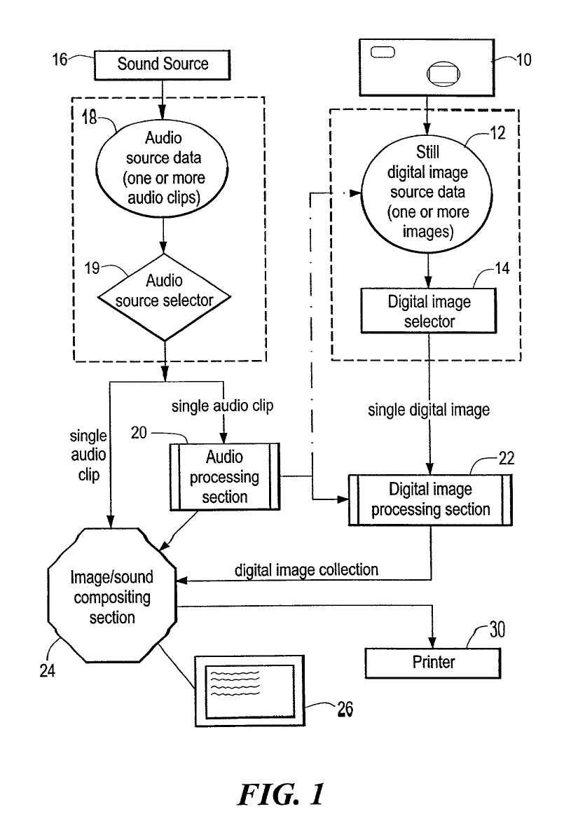

Referring to FIG. 1 in detail there is shown for illustrative purposes, a system embodying the present invention that deals with the production and presentation of images and sound. The images may be provided by any suitable source, such as a digital camera 10 whose digital image data is stored in memory 12 for selection by a selector 14. Images may also be provided, for example, from a scanner, a computer, a printer, a frame-grabber of a video system, the Internet, or represented in a software application.

The system also includes a source 16 of digital sounds. Any suitable sound source 16 such as a sound recording or clip, an MP3 software or hardware plug-in, or even live sound may be utilized. If the sound source is live, an analog to digital converter may be incorporated in the system to generate the digital audio data. The audio source data from the sound source 16 may be stored in a memory 18 connected to a selector 19 for selecting a desired sound.

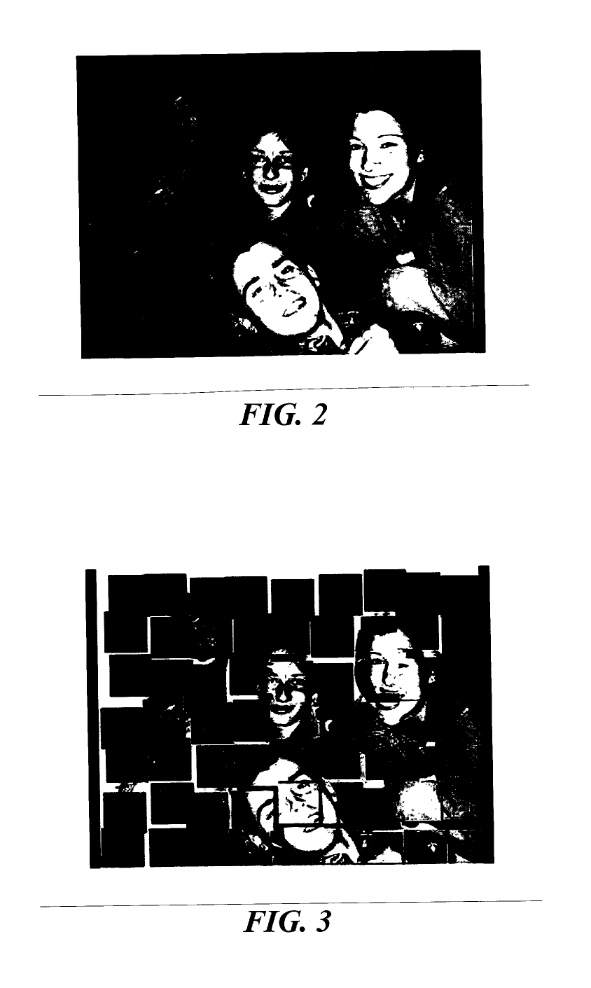

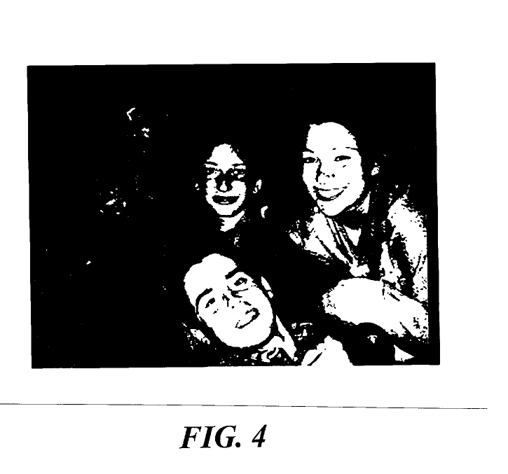

Certain characteristics are selected from a selected sound and transmitted to an audio processing station 20 of a computer for altering the selected image, for example changing the geometry or position of the image or portions thereof or changing the color of the image or portions thereof. For example, a sound characteristic such as a drum beat or whether the sound is considered “pop”, “slow” “fast” when identified could be used to alter the image appearing in FIG. 2 to provide, for instance, the altered image appearing in FIG. 3. The image of FIG. 3 represents a so-called “broken tile” effect and can be produced by a variety of known geometric transforms. Such geometric transforms segment, translate, rotate, resize or skew image images in a number of versions. For instance, a trumpet beat could be used to signal alteration of the color, tone scale or some other visual aspect of the image. FIG. 4 can be represented as a result of applying a known type of color transform; so as to provide a so-called “posterize” effect.

In the preferred embodiment, the audio processing section 20 uses algorithms, such as Discrete Cosine Transforms (DCT) to represent the audio data of the selected sound characteristics in a frequency or time domain.

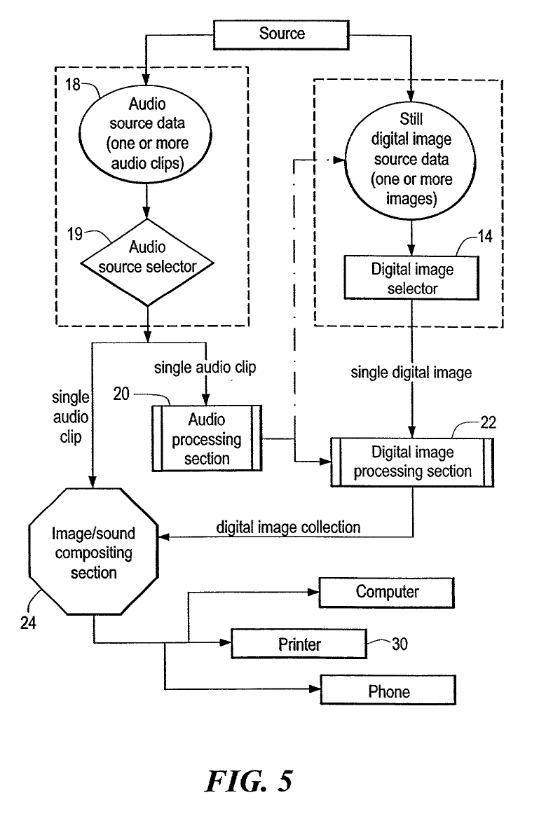

The selected digital data is altered at a processing station 22 of the computer in response to signals from the audio processing section 20 based on the selected sound characteristics of the selected sound which may be a single audio clip. The altered image and the associated sound may or may not be synchronized at a processing station 24 of the computer for display at a display station 26. The altered images may be continuously or sequentially displayed simultaneously with the sound. If desired, the system may be provided with a printer 30 for printing the altered image or images. The entire system may be incorporated in a digital camera with or without the printer 30, in a printer with or without the digital camera, in a scanner with or without the camera and/or printer. The system can represented on an integrated circuit or in the form of software or firmware and the altered images and sound can be downloaded to a computer. It will be further appreciated that images can be uploaded from the Internet with or without sound. FIG. 5 illustrates an embodiment, wherein the digital and sound sources are from a computer 40. FIG. 5 also illustrates a plurality of including a printer, phone or another computer.

In use the system of the present invention may process a single image or a plurality of images which may be displayed sequentially to produce from still images “instant” animated images with or without sound. For example in camera system, a user would: press a button for selecting a supplied image or a series of animated images for display after the image has been acquired; press a button for selecting music to be played along with the altered images; allowing the operator to select for displaying and/or printing altered images with or without the sound. It is also contemplated that the images can be altered independently of sound.

Various modifications and adaptations of the present invention will become readily apparent to those of ordinary skill in the art but without departing from the scope of the invention indicated in the appended claims.

What is claimed is:

1. A system for reproducing images in altered form in response to sound characteristics, the system comprising in combination, a source of at least one still digital image, a source of sound, an analyzer for analyzing the sound and selecting characteristics of the sound for altering an image, means for altering an image from said image source in accordance with said characteristics of the sound.

2. The system of claim 1, wherein at least one of said analyzer and/or said means for altering an image are processing sections of at least one of a group consisting of a digital camera, a scanner, a printer, a phone or a computer.

3. The system of claim 1, further including a display means for displaying the altered image.

4. The system of claims 1, further including means for displaying the altered image in synchronism with the sound.

5. The system defined in claim 1, further including storage means capable of storing altered images and the sound.

6. The system of claim 1, further including a printer for printing the altered images.

7. The system of claim 1, wherein said still digital image source is selected from a group consisting of a digital camera, a scanner, a computer, a printer, a framegrabber of a video system, a phone, and the internet.

8. The system of claim 1, including storage means for storing a plurality of digital images, and selection means for selecting an image to be altered from said storing means.

9. The system of claim 2, wherein said at least one of a group is a camera, and further including means for processing electronic sound data for altering an image produced by any one or combination of said group in accordance with characteristics of said sound data, and wherein a display means is incorporated by any one or combination of said group.

10. The system of claim 2, wherein said at least one of a group is a computer, and further including means for processing electronic sound data for altering an image produced by any one or combination of said group in accordance with characteristics of said sound data, and wherein a display means is incorporated by any one or combination of said group.

11. The system of claim 9, including means for sequentially reproducing altered images on said display in synchronism with sound produced from said sound source.

12. The system of claim 9, wherein said camera includes storage means for storing a plurality of digital images, selection means for selecting from said storage means an image to be altered, and means for sequentially reproducing altered images on said display in synchronism with sound from said sound source.

13. A method of reproducing images in altered form in response to sound characteristics, the method comprising the steps of providing a source of at least one still digital image, providing a source of sound, providing an analyzer for analyzing the sound and selecting characteristics of the sound for altering an image, providing means for altering an image, and altering an image from the image source in accordance with the characteristics of the sound.

14. The method of claim 13, further including a step whereby said analyzer and said means for altering an image are processing sections of at least one of a group consisting of a digital camera, a scanner, a printer, a phone or a computer.

15. The method of claim 13, further including a step of displaying the altered image on a display means.

16. The method of claim 13, further including a step for displaying the altered image in synchronism with the sound.

17. The method of claim 13, further including a step of storing altered digital images and the sound.

18. The method of claim 13, further including the step of printing the altered images.

19. The method of claim 13 further including a step of storing a plurality of digital images in a storage means, and a step of selecting the image to be altered from the storing means.

20. The method of claim 16, including the step of sequentially reproducing altered images on the display in synchronism with the produced sound.
